(19) United States
(12) Patent Application Publication
(10) Pub. No.: US 2026/0186291 A1
(43) Pub. Date: Jul. 2, 2026

(54) PERISCOPE MOTOR, CAMERA MODULE, AND ELECTRONIC DEVICE

(71) Applicant: Rayprus Technology (Foshan) Co., Ltd., Foshan (CN)

(72) Inventors: Sheng-Jie Ding, Jincheng (CN); Jing-Wei Li, Shenzhen (CN); Jia-Qi Wu, Jincheng (CN); Guo-Yu Liang, Foshan (CN); Zhi-Yuan Hu, Foshan (CN)

(21) Appl. No.: 19/066,522

(22) Filed: Feb. 28, 2025

(30) Foreign Application Priority Data
Dec. 30, 2024 (CN) 202411976610.5

(51) Int. Cl. G02B 23/08; G02B 26/08

(52) U.S. Cl. CPC G02B 23/08; G02B 26/0891

(57) ABSTRACT

A periscope motor, a camera module, and an electronic device are disclosed. By arranging the first groove on the side surface of the base and fixing the roller in the first groove, the roller on the side surface restricts the vertical movement of the mounting seat, thereby reducing the likelihood of the mounting seat colliding with adjacent structures, minimizing the risk of particle generation, reducing the probability of dents forming on the base, and consequently lowering the chances of dark shadows, black spots, or poor focusing during imaging.

### FIELD

The subject matter herein generally relates to camera device technology, and more particularly, to a periscope motor, a camera module having the periscope motor, and an electronic device having the camera module.

### BACKGROUND

To achieve telephoto function, electronic devices (e.g., smart phones) may have camera modules with telephoto lenses. Due to the large total track length of the telephoto lenses, it is difficult to mount such lenses into a thin terminal device. Thus, a periscope motor may be needed in the telephoto camera modules.

The existing periscope motor may move the lenses through a cooperation of balls and grooves to realize focusing or zooming. The balls and grooves may be arranged on the bottom surface of the base of the camera modules. During reliability testing, the structure inside the periscope motor for holding the lenses may collide with the base, leading to the generation of debris or particles. Additionally, the positions of the balls are prone to forming dents, which can cause issues such as dark shadows, black spots, and poor focusing properties during imaging.

Therefore, there is room for improvement in the art.

### BRIEF DESCRIPTION OF THE DRAWINGS

Implementations of the present disclosure will now be described, by way of embodiments only, with reference to the attached figures.

FIG. 1 is a diagram of an embodiment of a periscope motor according to the present disclosure.

FIG. 2 is an exploded view of the periscope motor of FIG. 1.

FIG. 3 is a diagrammatic view of a base of the periscope motor shown in FIG. viewed from another angle.

FIG. 4 is a cross-sectional view along IV-IV of FIG. 1.

FIG. 5 is a diagram of an embodiment of a camera module according to the present disclosure.

FIG. 6 is a diagram of an embodiment of an electronic device according to the present disclosure.

### DETAILED DESCRIPTION

Unless otherwise defined, all technical and scientific terms used herein have the same meaning as commonly understood by persons skill in the art. The terms used herein are only for the purpose of describing specific embodiments, and not intended to limit the embodiments of the present application.

It should be noted that all directional indications (such as up, down, left, right, front, back, etc.) in the embodiments of the present application are only used to explain the relative positional relationship or movement between various components under a certain posture (as shown in the drawings). If the specific posture changes, the directional indication also changes accordingly.

It should be noted that when a component is referred to as being “fixed on” or “mounted on” another component, it may be directly on the other component or there may also be an intervening component. When a component is considered to be “set on” another component, it may be in direct contact with the other component or there may also be an intervening component.

In the present application, descriptions such as “first”, “second” etc. are only used to distinguish between different objects, and should not be understood as indicating or implying relative importance, or as implicitly specifying the quantity, particular order, or a primary-secondary relationship of the technical features indicated.

The embodiments of the present application are described here with reference to sectional views, which are schematic diagrams of idealized embodiments (and intermediate structures) of the present application. Therefore, the difference in the shape of the drawing due to the manufacturing process and/or tolerance is predictable. Accordingly, the embodiments of the present application should not be interpreted as limited to the specific shape of the area illustrated here, but should include, for example, the deviation of the shape due to manufacturing. The areas shown in the drawings are only schematic, and their shape is not used to illustrate the actual shape of the device, and is not used to limit the scope of the present disclosure.

Some embodiments of the present application will be described in detail below with reference to the drawings. The following embodiments and features of the embodiments may be combined with each other in the absence of conflict.

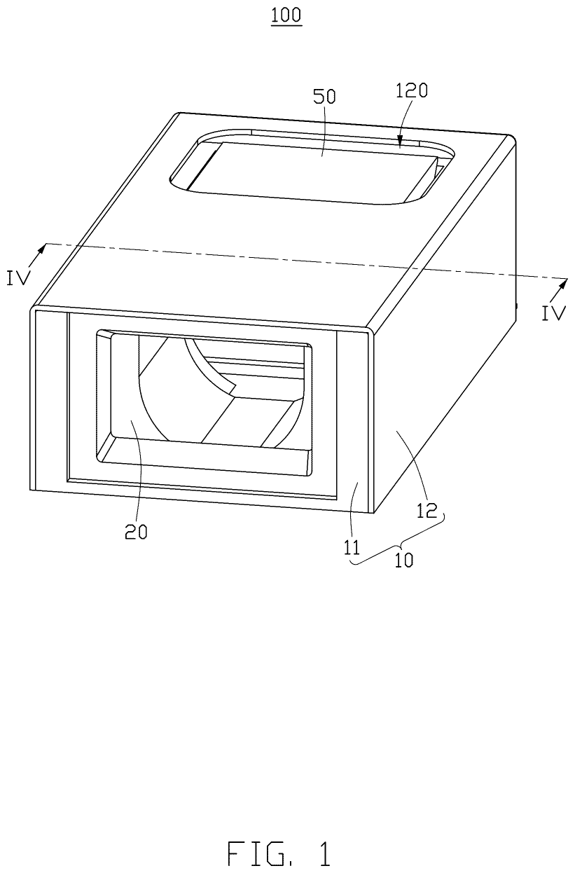

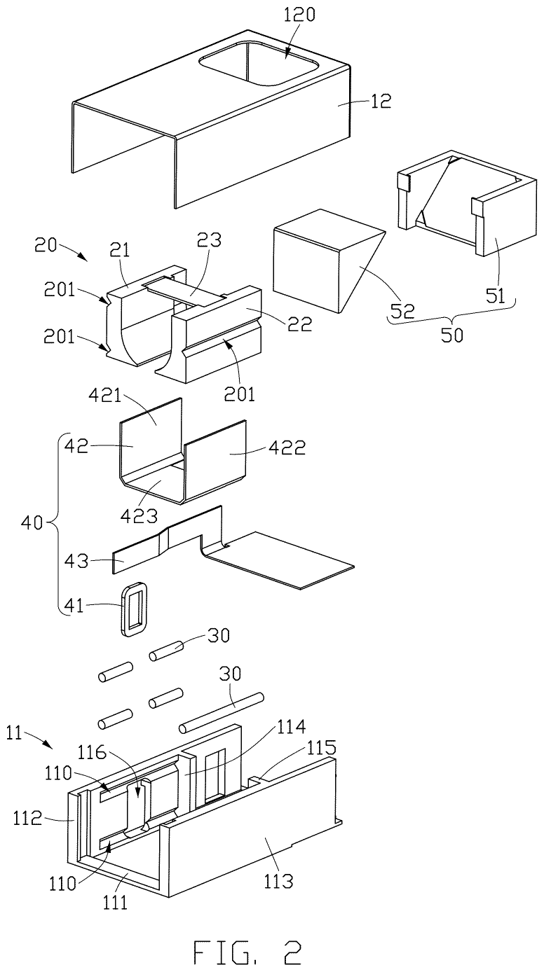

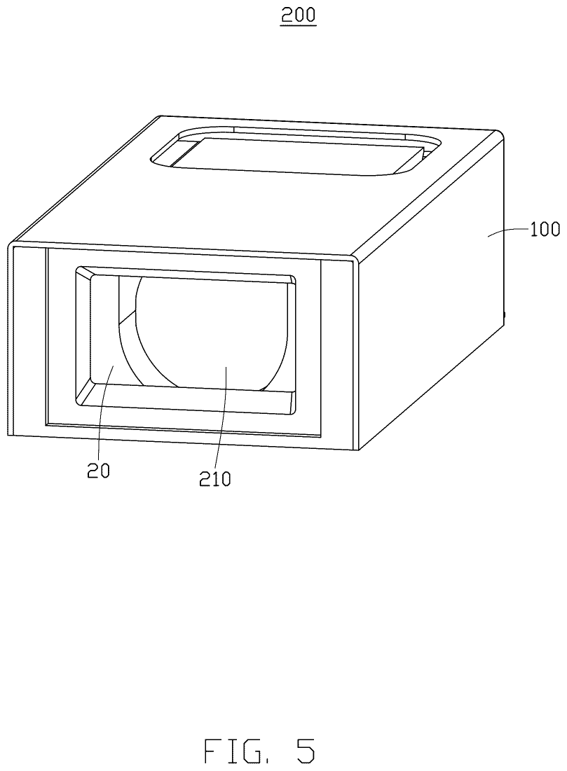

Referring to FIGS. 1 and 2, an embodiment of the present application provides a periscope motor 100 including a housing 10, a mounting seat 20, and a roller 30. The mounting seat 20 and the roller 30 are housed within the housing 10, and the housing 10 includes a base 11. The mounting seat 20 is movably connected to the base 11, that is, the mounting seat 20 can move relative to the base 11. The mounting seat 20 is configured to hold a lens 210 (referring to FIG. 5). The side surface of the base 11 facing the mounting seat 20 defines a first groove 110., and the side surface of the mounting seat 20 facing the base 11 defines a second groove 201. The second groove 201 corresponds to the first groove 110, meaning that the orthographic projection of the first groove 110 on the side surface of the mounting seat 20 at least partially overlaps with the orthographic projection of the second groove 201 on the side surface of the base 11, preferably coinciding exactly. The roller 30 is fixed in the first groove 110, and a portion of the roller 30 is housed in the second groove 201. The mounting seat 20 can move along the roller 30 under external force, thereby driving the lens mounted on the mounting seat 20 to perform focusing or anti-shake operations.

In the present application, by arranging the first groove 110 on the side surface of the base 11 and fixing the roller 30 in the first groove 110, the roller 30 on the side surface restricts the vertical movement of the mounting seat 20, thereby reducing the likelihood of the mounting seat 20 colliding with adjacent structures, minimizing the risk of particle generation, reducing the probability of dents forming on the base 11, and consequently lowering the chances of dark shadows, black spots, or poor focusing during imaging.

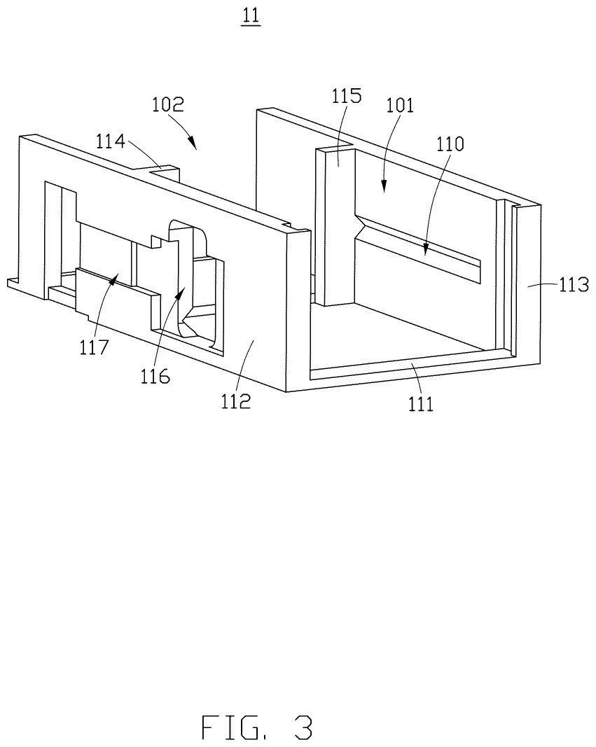

In some embodiments, as shown in FIGS. 2 and 3, the base 11 is a substantially hollow frame structure, including a bottom plate 111, a first side plate 112, and a second side plate 113. The mounting seat 20 is housed within the space enclosed by the bottom plate 111, the first side plate 112, and the second side plate 113. The first side plate 112 and the second side plate 113 extend upward from the two edges of the bottom plate 111, and the first side plate 112 and the second side plate 113 are connected to the bottom plate 111 and opposite to each other. It should be understood that the side surface of the base 11 facing the mounting seat 20 refers to the surface of the first side plate 112 facing the second side plate 113 and the surface of the second side plate 113 facing the first side plate 112. The first groove 110 is formed on the surface of the first side plate 112 facing the second side plate 113, and may also be formed on the surface of the second side plate 113 facing the first side plate 112. As shown in FIG. 2, the surface of the first side plate 112 facing the second side plate 113 is partially recessed in a direction away from the second side plate 113 to from the first groove 110. As shown in FIG. 3, the surface of the second side plate 113 facing the first side plate 112 is partially recessed in a direction away from the first side plate 112 to from the first groove 110. Along the thickness direction of the first side plate 112 or the second side plate 113, the first groove 110 only partially penetrates the first side plate 112 or the second side plate 113.

In this embodiment, the first side plate 112 includes two first grooves 110, and the second side plate 113 includes one first groove 110. Correspondingly, the surface of the mounting seat 20 facing the first side plate 112 includes two second grooves 201, and the surface of the mounting seat 20 facing the second side plate 113 includes one second groove 201. The two first grooves 110 on the first side plate 112 are spaced apart along the height direction of the first side plate 112, and each first groove 110 can accommodate one or more rollers 30. The extending directions of the first groove 110 and the second groove 201 are parallel to the direction of the optical path of the lens, and the direction of the optical path of the lens is approximately perpendicular to the height direction of the first side plate 112 (the second side plate 113). In other embodiments, the number of the first grooves 110 and second grooves 201 can be adjusted accordingly.

In some embodiments, as shown in FIG. 3, the surface of the first side plate 112 facing the second side plate 113 includes a first baffle 114, and the surface of the second side plate 113 facing the first side plate 112 includes a second baffle 115. The first baffle 114 protrudes from the first side plate 112, and the second baffle 115 protrudes from the second side plate 113. The first baffle 114 and the second baffle 115 are arranged correspondingly. The first baffle 114 and the second baffle 115 divide the base 11 into a first region 101 and a second region 102, which are arranged along the optical path direction of the lens. The mounting seat 20 is located in the first region 101. The first baffle 114 and the second baffle 115 ensure that the mounting seat 20 only moves within the first region 101, preventing the mounting seat 20 from moving into the second region 102.

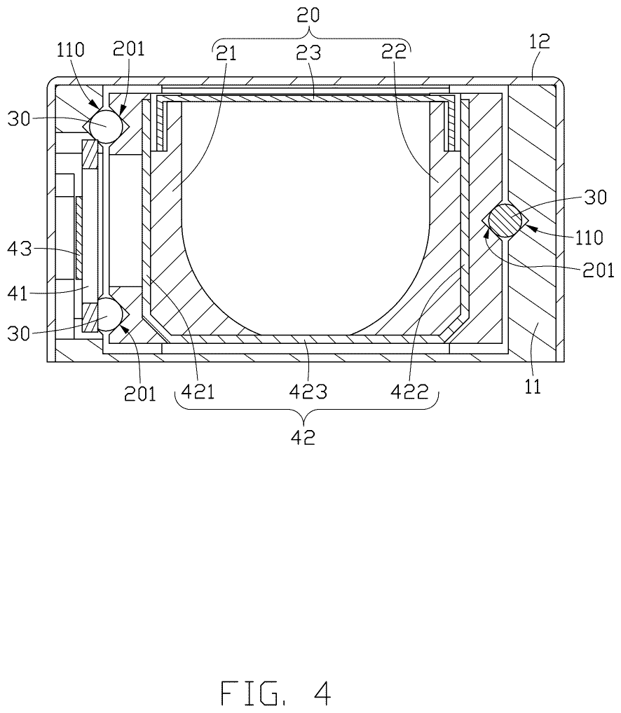

Referring to FIGS. 2 and 4, in some embodiments, the mounting seat 20 includes a first mounting portion 21 and a second mounting portion 22 arranged opposite to each other. The first mounting portion 21 is close to the first side plate 112, and the second mounting portion 22 is close to the second side plate 113. The surface of the first mounting portion 21 facing the second mounting portion 22 may be an arc-shaped surface, and the surface of the second mounting portion 22 facing the first mounting portion 21 may also be an arc-shaped surface. The two arc-shaped surfaces are adapted to the shape of the lens. The surface of the first mounting portion 21 facing the first side plate 112 defines a second groove 201, which may be formed by a portion of the surface of the first mounting portion 21 facing the first side plate 112 recessing away from the first side plate 112. The surface of the second mounting portion 22 facing the second side plate 113 also defines a second groove 201, which may be formed by a portion of the surface of the second mounting portion 22 facing the second side plate 113 recessing away from the second side plate 113. The second groove 201 corresponds to the first groove 110, and the second groove 201 and the first groove 110 together form a housing space for the roller 30.

Furthermore, the mounting seat 20 also includes a third mounting portion 23 connecting the first mounting portion 21 and the second mounting portion 22. One end of the third mounting portion 23 is fixed to the surface of the first mounting portion 21 away from the bottom plate 111 (i.e., the upper surface of the first mounting portion 21 in FIGS. 2 and 4), and the other end is fixed to the surface of the second mounting portion 22 away from the bottom plate 111 (i.e., the upper surface of the second mounting portion 22 in FIGS. 2 and 4). The third mounting portion 23 can restrict the vertical movement of the lens mounted in the mounting seat 20.

In some embodiments, as shown in FIGS. 2 and 4, the periscope motor 100 also includes a driving assembly 40, which can drive the mounting seat 20 to move. The driving assembly 40 includes a coil 41 and a magnetic member 42. The first side plate 112 includes a through slot 116 penetrating the first side plate 112, and the coil 41 is fixed in the through slot 116. Along the height direction of the first side plate 112, the through slot 116 may penetrate the two first grooves 110, dividing each first groove 110 into two parts, with each part capable of accommodating a roller 30 respectively. The magnetic member 42 is fixed in the mounting seat 20, and at least a portion of the magnetic member 42 corresponds to the coil 41, meaning that at least a portion of the magnetic member 42 is within the magnetic field range generated by the coil 41. When the coil 41 is energized, the coil 41 generates a magnetic force, which acts on the magnetic member 42, thereby driving the mounting seat 20 to move along the roller 30. The magnetic member 42 may be, but is not limited to, a yoke.

Furthermore, the magnetic member 42 may include a first portion 421, a second portion 422, and a connecting portion 423 connecting the first portion 421 and the second portion 422. The first portion 421 and the second portion 422 are arranged opposite to each other. The cross-section of the magnetic member 42 can be U-shaped. The first portion 421 can be inserted (embedded) into the first mounting portion 21 of the mounting seat 20, and the second portion 422 can be inserted into the second mounting portion 22 of the mounting seat 20. At least a portion of the surface of the first mounting portion 21 facing the bottom plate 111 and the surface of the second mounting portion 22 facing the bottom plate 111 are in contact with the connecting portion 423, thereby fixing the magnetic member 42 to the mounting seat 20.

In some embodiments, as shown in FIGS. 2 to 4, the driving assembly 40 also includes a circuit board 43. As shown in FIG. 3, the surface of the first side plate 112 facing away from the second side plate 113 defines a third groove 117, which is communicating with the through slot 116. A portion of the circuit board 43 is housed in the third groove 117 and extends into the through slot 116 to connect with the coil 41, thereby supplying power to the coil 41. The circuit board 43 may be, but is not limited to, a flexible printed circuit (FPC).

In some embodiments, as shown in FIG. 2, the periscope motor 100 also includes a light-deflecting assembly 50, which is located in the second region 102 of the base 11. The light-deflecting assembly 50 includes a bracket 51 and a prism 52. The bracket 51 is fixed in the second region 102 of the base 11, and the prism 52 is fixed on the bracket 51. The prism 52 is used to deflect the optical path of incident light by 90° before it enters the lens, allowing the lens and other components to lie flat, thereby reducing the overall height. The prism 52 may be a triangular prism.

In some embodiments, as shown in FIGS. 1 and 2, the housing 10 also includes a top cover 12. The top cover 12 is placed over the base 11, forming an enclosed space with the base 11. The top cover 12 defines an opening 120, through which the prism 52 is exposed. The opening 120 allows light to enter the prism 52.

Referring to FIG. 5, an embodiment of the present application provides a camera module 200, which includes a lens 210 and the periscope motor 100 described above. The lens 210 is mounted in the mounting seat 20 of the periscope motor 100, and the lens 210 can move with the movement of the mounting seat 20. The light reflected by the prism 52 enters the lens 210. Of course, the camera module 200 also includes structures such as a photosensitive chip and a filter, which will not be described in detail here.

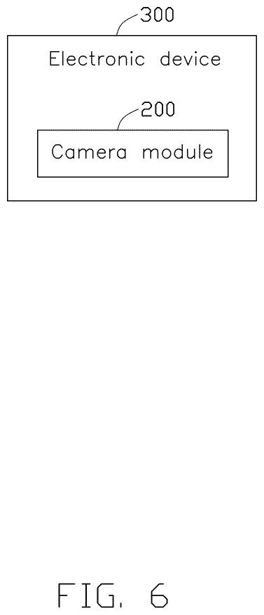

Referring to FIG. 6, an embodiment of the present application provides an electronic device 300, which includes the camera module 200 described above. For example, the electronic device 300 may be a smartphone.

The periscope motor 100 of the present application arranges the first groove 110 on the side surface of the base 11 and fix the roller 30 in the first groove 110, and the roller 30 on the side surface restricts the vertical movement of the mounting seat 20, thereby reducing the likelihood of the mounting seat 20 colliding with adjacent structures, minimizing the risk of particle generation, reducing the probability of dents forming on the base 11, and consequently lowering the chances of dark shadows, black spots, or poor focusing during imaging.

The above descriptions are some specific embodiments of the present application, but the actual application process cannot be limited only to these embodiments. For those of ordinary skill in the art, other modifications and changes made according to the technical concept of the present application should all belong to the protection scope of the present application.

What is claimed is:

1. A periscope motor comprising:
a housing comprising a base;
a mounting seat movably connected to the base, wherein a side surface of the base facing the mounting seat defines a first groove, a side surface of the mounting seat facing the base defines a second groove, and the second groove corresponds to the first groove; and
a roller fixed in the first groove, wherein the mounting seat is configured to move along the roller.

2. The periscope motor of claim 1, wherein the base comprises a bottom plate, a first side plate, and a second side plate, the first side plate and the second side plate are connected to the bottom plate and opposite to each other; the first groove is defined on a surface of the first side plate facing the second side plate, and the first groove is further defined on a surface of the second side plate facing the first side plate.

3. The periscope motor of claim 2, further comprising a driving assembly comprising a coil and a magnetic member, wherein the first side plate defines a through slot penetrating the first side plate, the coil is fixed in the through slot, the magnetic member is fixed in the mounting seat, and at least a portion of the magnetic member corresponds to the coil.

4. The periscope motor of claim 3, wherein the driving assembly further comprises a circuit board, a surface of the first side plate facing away from the second side plate defines a third groove communicating with the through slot, and a portion of the circuit board is received in the third groove and extends into the through slot to connect to the coil.

5. The periscope motor of claim 3, wherein the mounting seat comprises a first mounting portion and a second mounting portion opposite to each other, the second groove is defined on a surface of the first mounting portion facing the first side plate, and the second groove is further defined on a surface of the second mounting portion facing the second side plate.

6. The periscope motor of claim 5, wherein the magnetic member comprises a first portion, a second portion, and a connecting portion connecting the first portion to the second portion, the first portion is inserted into the first mounting portion, and the second portion is inserted into the second mounting portion.

7. The periscope motor of claim 2, further comprising a first baffle and a second baffle, wherein the first baffle is arranged on a surface of the first side plate facing the second side plate, the second baffle is arranged on a surface of the second side plate facing the first side plate, the first baffle and the second baffle divide the base into a first region and a second region, and the mounting seat is located in the first region.

8. The periscope motor of claim 7, further comprising a light-deflecting assembly located in the second region, wherein the light-deflecting assembly comprises a bracket and a prism, the bracket is fixed in the second region, and the prism is fixed on the bracket.

9. The periscope motor of claim 8, wherein the housing further comprises a top cover placed over the base, the top cover defines an opening, and the prism is exposed from the opening.

10. A camera module comprising a lens and a periscope motor, the periscope motor comprising:
a housing comprising a base;
a mounting seat movably connected to the base, wherein the lens is arranged in the mounting seat, a side surface of the base facing the mounting seat defines a first groove, a side surface of the mounting seat facing the base defines a second groove, and the second groove corresponds to the first groove; and
a roller fixed in the first groove, wherein the mounting seat is configured to move along the roller.

11. The camera module of claim 10, wherein the base comprises a bottom plate, a first side plate, and a second side plate, the first side plate and the second side plate are connected to the bottom plate and opposite to each other; the first groove is defined on a surface of the first side plate facing the second side plate, and the first groove is also defined on a surface of the second side plate facing the first side plate.

12. The camera module of claim 11, wherein the periscope motor further comprises a driving assembly comprising a coil and a magnetic member, the first side plate defines a through slot penetrating the first side plate, the coil is fixed in the through slot, the magnetic member is fixed in the mounting seat, and at least a portion of the magnetic member corresponds to the coil.

13. The camera module of claim 12, wherein the driving assembly further comprises a circuit board, a surface of the first side plate facing away from the second side plate defines a third groove communicating with the through slot, and a portion of the circuit board is received in the third groove and extends into the through slot to connect to the coil.

14. The camera module of claim 12, wherein the mounting seat comprises a first mounting portion and a second mounting portion opposite to each other, the second groove is defined on a surface of the first mounting portion facing the first side plate, and the second groove is further defined on a surface of the second mounting portion facing the second side plate.

15. The camera module of claim 14, wherein the magnetic member comprises a first portion, a second portion, and a connecting portion connecting the first portion to the second portion, the first portion is inserted into the first mounting portion, and the second portion is inserted into the second mounting portion.

16. The camera module of claim 11, wherein the periscope motor further comprises a first baffle and a second baffle, the first baffle is arranged on a surface of the first side plate facing the second side plate, the second baffle is arranged on a surface of the second side plate facing the first side plate, the first baffle and the second baffle divide the base into a first region and a second region, and the mounting seat is located in the first region.

17. The camera module of claim 16, wherein the periscope motor further comprises a light-deflecting assembly located in the second region, the light-deflecting assembly comprises a bracket and a prism, the bracket is fixed in the second region, and the prism is fixed on the bracket.

18. The camera module of claim 17, wherein the housing further comprises a top cover placed over the base, the top cover defines an opening, and the prism is exposed from the opening.

19. An electronic device comprising a camera module, the camera module comprising:
a housing comprising a base;
a mounting seat movably connected to the base, wherein a side surface of the base facing the mounting seat defines a first groove, a side surface of the mounting seat facing the base defines a second groove, and the second groove corresponds to the first groove;
a roller fixed in the first groove, wherein the mounting seat is configured to move along the roller; and
a lens arranged in the mounting seat.

20. The electronic device of claim 19, wherein the electronic device is a smart phone.
